(19) United States
(12) Patent Application Publication
(10) Pub. No.: US 2025/0360976 A1
(43) Pub. Date: Nov. 27, 2025

(54) MODIFIED PRECISION MID-ROLLER WHEELS FOR QUADTRACS AND DUST CUPS USED THEREFOR

(71) Applicant: Dale Robert Booms, Harbor Beach, MI (US)

(72) Inventor: Dale Robert Booms, Harbor Beach, MI (US)

(21) Appl. No.: 18/671,336

(22) Filed: May 22, 2024

(51) Int. Cl. B62D 55/15

(52) U.S. Cl. CPC B62D 55/15

(57) ABSTRACT

Mid-roller wheels and dust caps useful for Quadtrac type heavy equipment. The dust caps and seals useful herein are dependent on precision in sizing and configuration. Mid-roller wheels and dust caps are useful in wheel assemblies, especially wheel and track driven farm tractors (Quadtrac) and includes wagons and other gear subjected to harsh environments such as heavy equipment, such as backhoes, bulldozers, and the like.

### CROSS-REFERENCE TO RELATED APPLICATIONS

PRELOAD ASSEMBLY FOR ROLLER BEARINGS filed Jan. 26, 2021, as Ser. No. 17/158,054; PRELOAD ASSEMBLY FOR ROLLER BEARINGS filed Aug. 9, 2022, as Ser. No. 17/818,461; PRELOAD ASSEMBLY FOR ROLLER BEARINGS filed Nov. 30, 2023, as Ser. No. 18/524,633, and MODIFIED BIDIRECTIONAL CASSETTE SEALS USEFUL IN WHEEL ASSEMBLIES filed Mar. 6, 2024, as Ser. No. 18/596,828.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

This invention deals with mid-roller wheels and dust caps useful therefor. The dust caps and seals useful herein are dependent on precision in sizing and configuration.

This invention is useful in wheel assemblies, especially wheel and track driven farm tractors (Quadtrac) and includes wagons and other gear subjected to harsh environments such as heavy equipment, such as backhoes, bulldozers, and the like. FIG. 1 is a full side view of a driving mechanism 1 for Quadtrac vehicles wherein there is shown the mid-roller wheel assemblies 2.

Component parts for Quadtrac mid-roller wheels are expensive and therefore any means by which the wheels can be protected while in use enhances the amount of time of use of the vehicle before having to repair.

Unmodified mid-roller wheels and components have been manufactured by very few manufacturers and recently, certain parts for the wheels have been difficult to purchase and use as certain manufacturers have ceased manufacture of the parts. This invention seeks to provide modified, that is, upgraded components for use and repair of Quadtrac mid-roller wheels.

### BRIEF SUMMARY OF THE INVENTION

A first embodiment of this invention is a modified mid-roller wheel for a quadtrac vehicle. The modified mid-roller wheel comprises a covered metal wheel having an outside width of 7 to 9 inches; an outside diameter of the wheel including the covering of 13.25 to 13.75 inches; an outside diameter of the metal wheel of 12.100 to 12.150 inches, and an inside diameter of the metal wheel of 10.875 to 10.885 inches.

In a second embodiment of this invention there is a modified dust cap for the mid-roller wheel. The modified dust cup comprises a cup diameter of 4.920±0.001 inches; a wall thickness of 0.4435±0.0005 inches; an inside ridge having a diameter of 4.475±0.0005 inches, and the diameter of a centered opening being 2.5578±0.0000 to ±0.0005 inches. The modified dust cap is manufactured from metal and preferred for this invention is cast iron and mostly preferred is steel.

Yet another embodiment of this is a combination of a modified mid-roller wheel for a quadtrac vehicle, said modified mid-roller wheel comprising a covered metal wheel having an outside width of 7 to 9 inches; an outside diameter of said wheel including said covering of 13.25 to 13.75 inches; an outside diameter of said metal wheel of 12.100 to 12.150 inches; an inside diameter of a metal wheel of 10.875 to 10.885 inches, and a modified dust cap of this invention, and a modified bidirectional cassette seal contained in the modified dust cap.

A further embodiment of this invention is a modified dust cap for the mid-roller wheel, the modified dust cup, with regard to FIG. 2 comprises the following components: a) is the diameter of a top ring; b) is the thickness of said dust cup including said top ring; c) is the thickness of said dust cup not including said top ring; d) is the radius of an outside top edge; e) is a chamfered inside edge; f) is the radius of said inside wall bend and a channel inside edge; g) is the radius of said inside ring; h) is a channel outside edge; i) is the depth of said channel from a bottom edge of said cup; j) is the depth of an inner ring from said bottom edge, wherein: a) is from 3.300 to 3.320 inches; b) is from 0.970 to 0.980 inches; c) is from 0.845 to 0.865 inches; d) is from 0.23 to 0.27 inches; e) is from 0.045 to 0.055 inches; f) is from 0.035 to 0.045 inches; g) is from 0.070 to 0.074 inches; h) is from 38 to 42 degrees flat; i) is from 0.560 to 0.566 inches, and j) is from 0.500 to 0.520 inches.

One other embodiment of this invention is a combination of a modified mid-roller wheel for a Quadtrac vehicle, wherein the modified mid-roller wheel comprises a covered metal wheel having an outside width of 7 to 9 inches; an outside diameter of the wheel including the covering of 13.25 to 13.75 inches; an outside diameter of the metal wheel of 12.100 to 12.150 inches; an inside diameter of the metal wheel of 10.875 to 10.885 inches, and a modified dust cap of this invention.

### BRIEF DESCRIPTION OF THE SEVERAL VIEWS OF THE DRAWING(S)

FIG. 1 is a full side view of a Quadtrac driving mechanism for farm vehicles and heavy equipment.

FIG. 2 is a full back view of a dust cap of this invention.

FIG. 3 is a full cross-sectional view of FIG. 2 through line A-A of FIG. 2.

FIG. 4 is a full front view of the dust cap of FIG. 2.

FIG. 5 is a full front view of a mid-roller wheel of this invention.

FIG. 6 is a full cross-sectional view of the wheel of FIG. 5 referred to herein as the “8 inch” wheel.

FIG. 7 is a full front view of another wheel embodiment of this invention referred to as the “7 inch” wheel.

FIG. 8 is an exploded view of a portion of a vehicle axle showing the component parts of a wheel assembly of this invention.

### DETAILED DESCRIPTION OF THE INVENTION

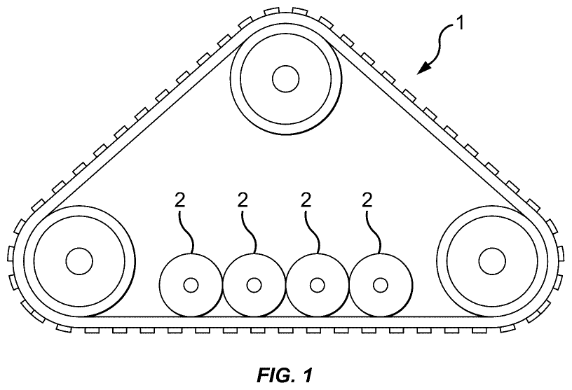

FIG. 1 is a full side view of a Quadtrac driving mechanism for a tractor or other heavy equipment. There is shown the mid-roller wheels 2 as a significant part of the entire assembly.

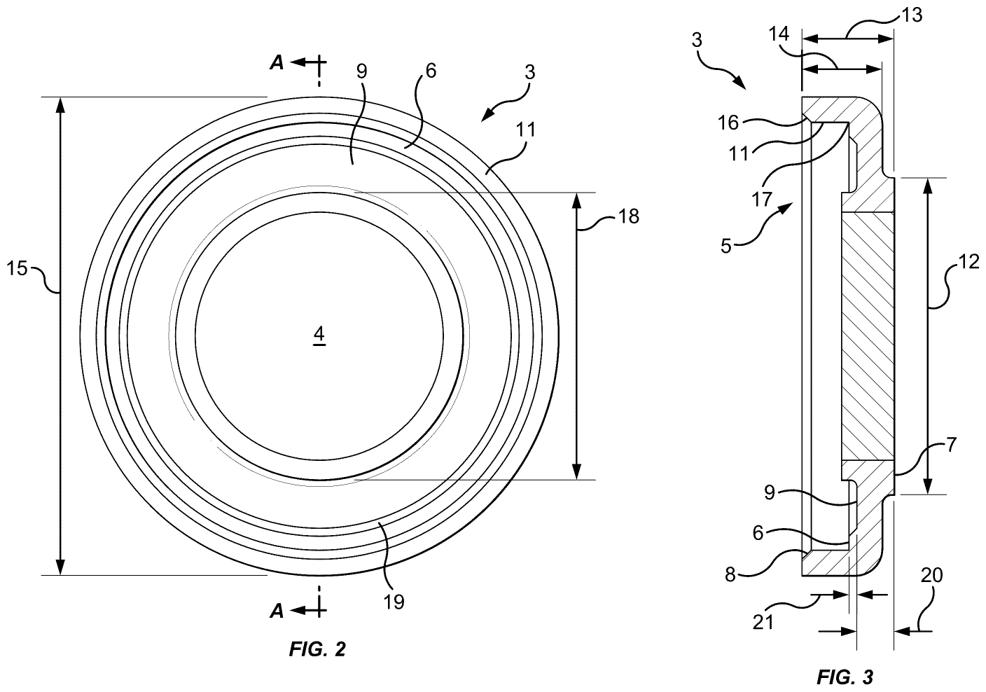

FIG. 2 is a full back view of a dust cap 3 of this invention in which there is shown a centered opening 4. For purposes of this description, the terms “dirt cup” and “dust cup” are used interchangeably. The center opening 4 in the inventive dust cap 3 of this invention is enlarged from prior art dust caps by 0.71 thousands of an inch to accommodate the remaining components on an axle of a modified Quadtrac mid-roller wheel of this invention.

FIG. 3 is a full cross-sectional view of the dirt cup 3 as shown in FIG. 2, along the line A-A.

With regard to FIGS. 2 and 3, the dust cap 3 of this invention further comprises a vertical wall 11 and it should be noted from FIG. 3 that the inside surface 5 of the dust cap 3 is vertical while prior art dust caps provide a sloped interior corner.

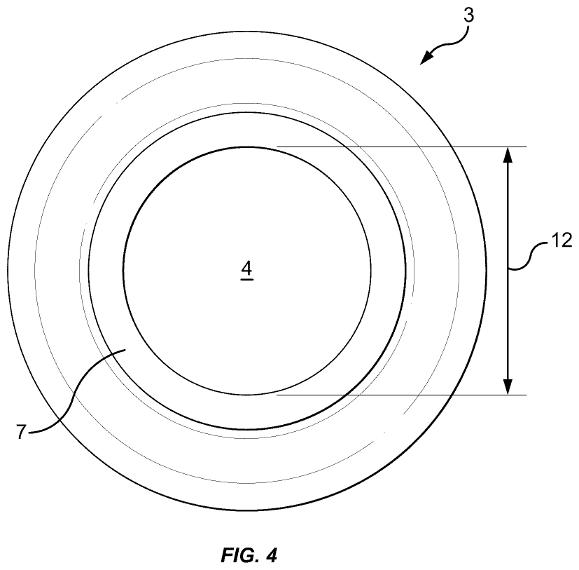

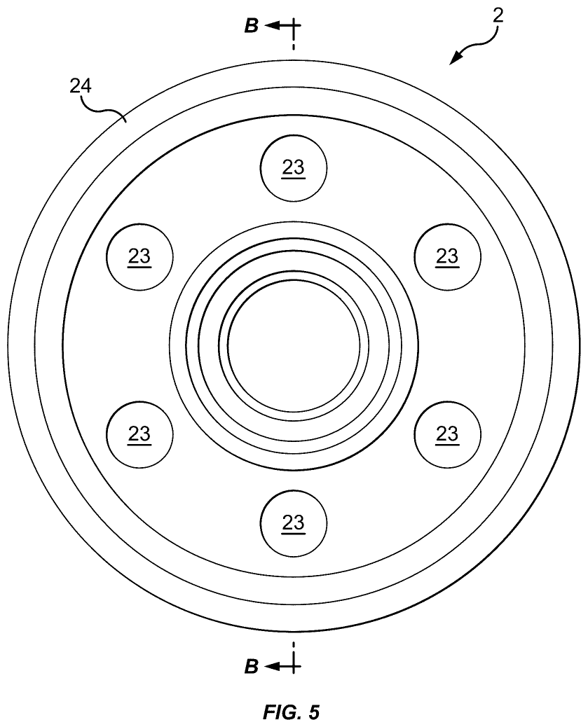

There is a circular ring 6 on the interior of the dust cup 3 and an exterior ring 7 on the opposite side (front see FIG. 4). The vertical wall 11 has a chamfered edge 16 on the top interior corner of the vertical wall 11.

There is a circular channel 9 on the interior of the dust cap 3 that accommodates a modified bidirectional cassette seal 10 (see FIG. 10) that is discussed infra.

Preferred dimensions for the dust cup are, with regard to FIG. 2, comprises the following components: a) is the diameter of a top ring 12; b) is the thickness of said dust cup including said top ring 13; c) is the thickness of said dust cup not including said top ring 14; d) is the radius of an outside top edge 15; e) is a chamfered inside edge 16; f) is the radius of said inside wall bend and a channel inside edge 17; g) is the radius of said inside ring 18; h) is a channel outside edge 19; i) is the depth of said channel from a bottom edge of said cup 20; j) is the depth of an inner ring from said bottom edge 21, wherein: a) is from 3.300 to 3.320 inches; b) is from 0.970 to 0.980 inches; c) is from 0.845 to 0.865 inches; d) is from 0.23 to 0.27 inches; e) is from 0.045 to 0.055 inches; f) is from 0.035 to 0.045 inches; g) is from 0.070 to 0.074 inches; h) is from 38 to 42 degrees flat; i) is from 0.560 to 0.566 inches, and j) is from 0.500 to 0.520 inches.

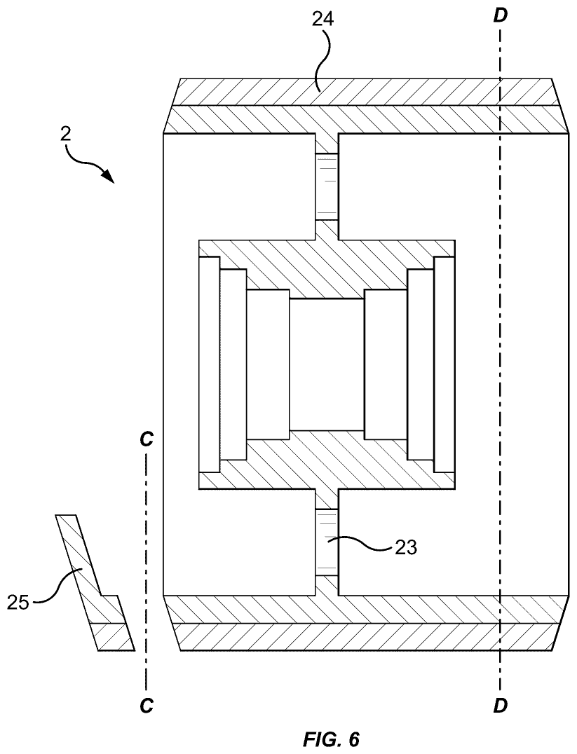

Turning now to FIG. 5 which is a full front view of a mid-roller wheel 22. Shown is a conventional prior art metal wheel 22 and openings 23 to allow cooling of the component parts. There is shown the covering 24. FIG. 6 is a cross-sectional view of a wheel of FIG. 5 through line B-B.

The wheel shown in FIG. 6 is an 8-inch-wide wheel that is created by chopping off part 25 through line C-C to provide the 8-inch-wide wheel of this invention.

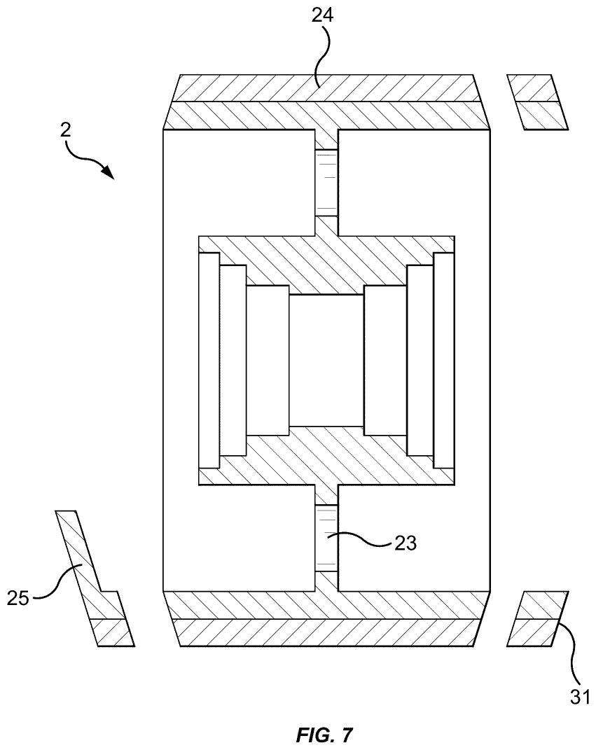

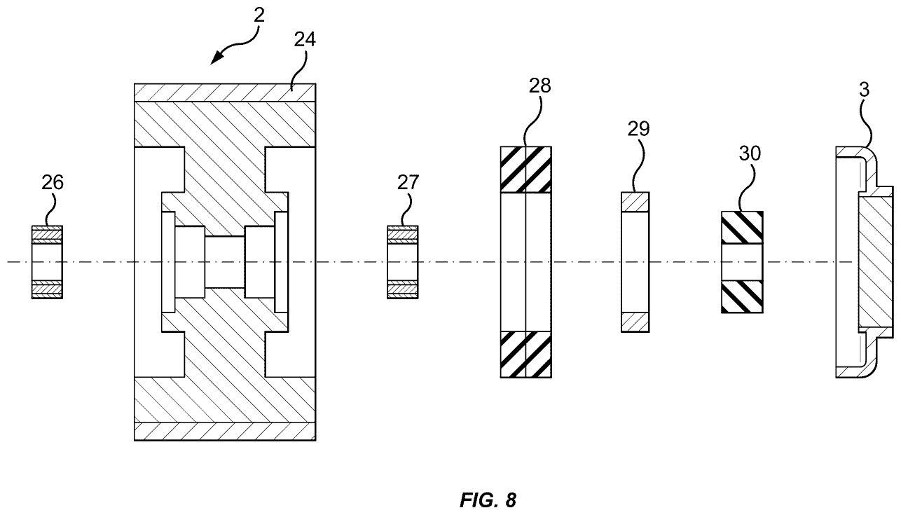

Another like wheel of this invention is created by chopping through line C-C and line D-D to create parts 25 and 31 to provide a seven-inch wheel of this invention. FIG. 7 is the seven-inch wheel.

Embodied in this invention is the combination of the modified mid-roller wheel and a modified dust cap.

Further embodied in this invention is a combination of the modified mid-roller of this invention, a modified dust cap of this invention and a modified bidirectional cassette seal contained in the modified dust cap.

A modified bidirectional cassette seal is a specialized seal that comprises a metal ring component partially embedded in a fluoroelastomer, the fluoroelastomer being heat resistant up to 300° C. The fluoroelastomer is water, heat and chemical resistant and the seal has an internal diameter of 55 mm to 170 mm and an outside diameter of 80 mm to 200 mm.

Turning now to FIG. 9, there is shown an expanded portion of an axle assembly using some components of this invention. Therein is shown a wheel 2 of this invention with a covering 24. Reading from left to right, there is shown a tapered bearing 26 (prior art), a wheel 2 of this invention, another tapered bearing 27 (prior art) an outer seal 28 (prior art), a modified bidirectional cassette seal 29, an inner seal 30 (prior art), and a dirt cup 3 of this invention.

What is claimed is:

1. A modified mid-roller wheel for a quadtrac vehicle, said modified mid-roller wheel comprising:
A) a covered metal wheel having an outside width of 7 to 9 inches;
B) an outside diameter of said wheel including said covering of 13.25 to 13.75 inches;
C) an outside diameter of said metal wheel of 12.100 to 12.150 inches;
D) an inside diameter of said metal wheel of 10.875 to 10.885 inches.

2. A modified dust cap for the mid-roller wheel as claimed in claim 1, said modified dust cup comprising:
i) a cup diameter of 4.920±0.001 inches;
ii) a wall thickness of 0.4435±0.0005 inches;
iii) an inside ridge having a diameter of 4.475±0.0005 inches, and
iv) the diameter of a centered opening being 2.5578±0.0000 to ±0.0005 inches.

3. A modified dust cap for the mid-roller wheel as claimed in claim 1, said modified dust cup, with regard to FIG. 1 comprising:
a) is the diameter of a top ring;
b) is the thickness of said dust cup including said top ring;
c) is the thickness of said dust cup not including said top ring;
d) is the radius of an outside top edge;
e) is a chamfered inside edge;
f) is the radius of said inside wall bend and a channel inside edge;
g) is the radius of said inside ring;
h) is a channel outside edge;
i) is the depth of said channel from a bottom edge of said cup;
j) is the depth of an inner ring from said bottom edge, wherein:
a) is from 3.300 to 3.320 inches;
b) is from 0.970 to 0.980 inches;
c) is from 0.845 to 0.865 inches;
d) is from 0.23 to 0.27 inches;
e) is from 0.045 to 0.055 inches;
f) is from 0.035 to 0.045 inches;
g) is from 0.070 to 0.074 inches;
h) is from 38 to 42 degrees flat;
i) is from 0.560 to 0.566 inches, and
j) is from 0.500 to 0.520 inches.

4. In combination, a modified mid-roller wheel for a quadtrac vehicle, said modified mid-roller wheel comprising:
A) a covered metal wheel having an outside width of 7 to 9 inches;
B) an outside diameter of said wheel including said covering of 13.25 to 13.75 inches;
C) an outside diameter of said metal wheel of
12.100 to 12.150 inches;
D) an inside diameter of metal wheel of 10.875 to 10.885 inches, and a modified dust cap as claimed in claim 3.

5. The modified dust cap for a mid-roller wheel as claimed in claim 3 wherein the modified dust cap is manufactured from metal.

6. The modified dust cap for a mid-roller wheel as claimed in claim 5 wherein the metal is cast iron.

7. The modified dust cap for a mid-roller wheel as claimed in claim 5 wherein the metal is steel.

8. In combination, a modified mid-roller wheel for a quadtrac vehicle, said modified mid-roller wheel comprising:
A) a covered metal wheel having an outside width of 7 to 9 inches;
B) an outside diameter of said wheel including said covering of 13.25 to 13.75 inches;
C) an outside diameter of said metal wheel of 12.100 to 12.150 inches;
D) an inside diameter of metal wheel of 10.875 to 10.885 inches, and
a modified dust cap as claimed in claim 3, and a
modified bidirectional cassette seal contained in said modified dust cap.
